(19) United States
(12) Patent Application Publication
(10) Pub. No.: US 2025/0299548 A1
(43) Pub. Date: Sep. 25, 2025

(54) INFORMATION PROCESSING DEVICE, DISPLAY CONTROL METHOD, AND NON-TRANSITORY COMPUTER READABLE MEMORY

(71) Applicant: Rakuten Group, Inc., Tokyo (JP)

(72) Inventor: Asaki MATSUMOTO, Tokyo (JP)

(73) Assignee: Rakuten Group, Inc., Tokyo (JP)

(21) Appl. No.: 19/082,290

(22) Filed: Mar. 18, 2025

(30) Foreign Application Priority Data
Mar. 19, 2024 (JP) 2024-043315

(51) Int. Cl. G08B 21/02; G08B 21/22

(52) U.S. Cl. CPC G08B 21/02; G08B 21/22

(57) ABSTRACT

The base management server MS causes a worker terminal Tm used by a worker Wm inspecting a drone Dn at a drone base Bm to display a notification list notifications including drone information of a plurality of the drones Dn under control of the drone base Bm, identifies a drone status of each of the drones Dn, identifies a notification priority of each drone Dn based on the identified drone status, and controls the display of the notification list according to the identified notification priority.

### CROSS REFERENCE TO RELATED APPLICATION

This application claims priority from Japanese Patent Application No. 2024-043315 which was filed on Mar. 19, 2024, the disclosure of which is herein incorporated by reference in its entirety.

### TECHNICAL FIELD

One or more embodiments of the present invention relate to a technical field of a system for a base where a plurality of unmanned aerial vehicles can take off and land.

### RELATED ART

Conventionally, there is a known technology that allows unmanned aerial vehicles such as drones to automatically perform inspections before take-off. For example, the drone disclosed in JP 2021-191675 A includes, as a configuration for diagnosing whether conditions for safely flying and spraying chemicals are satisfied before take-off, an airframe position confirmation unit, a nose confirmation unit, a peripheral confirmation unit, and the like. Furthermore, the drone includes an airframe visual check unit. The airframe visual check unit functions to instruct a user of points of visual check through a controller. This allows the user to efficiently inspect the drone.

By the way, when the unmanned aerial vehicle takes off or lands at a port within the base where the plurality of the unmanned aerial vehicles can take off and land, a worker who inspect each unmanned aerial vehicle needs to leave the port for safety. Therefore, it is conceivable to notify the worker of information regarding the unmanned aerial vehicle (e.g., information regarding take-off or landing of the unmanned aerial vehicle). However, if the worker simultaneously receives the respective notifications for the plurality of the unmanned aerial vehicles, it may take time to decide the notification for which unmanned aerial vehicle should be prioritized, thereby necessary action may be delayed.

Therefore, one or more embodiments of the present invention are to providing an information processing device, a display control method, and a non-transitory computer readable memory which are capable of causing the worker performing the inspection of the unmanned aerial vehicles to quickly decide the notification for which unmanned aerial vehicle should be prioritized.

### SUMMARY

(An aspect 1) In response to the above issue, an information processing device includes: at least one memory configured to store program code; and at least one processor configured to access the program code and operate as instructed by the program code. The program code includes: first display control code configured to cause the at least one processor to display, on a terminal, a notification list of notifications including information on each of a plurality of unmanned aerial vehicles under control of a base for the plurality of the unmanned aerial vehicles, the terminal being used by a worker who performs an inspection for each of the plurality of the unmanned aerial vehicles at the base; first identification code configured to cause the at least one processor to identify a status of each of the plurality of the unmanned aerial vehicles; and second display control code configured to cause the at least one processor to control, based on the status of each of the plurality of the unmanned aerial vehicles, the display of the notification list.

(An aspect 2) A display control method executed by one or more computers, includes: displaying, on a terminal, a notification list of notifications including information on each of a plurality of unmanned aerial vehicles under control of a base for the plurality of the unmanned aerial vehicles, the terminal being used by a worker who performs an inspection for each of the plurality of the unmanned aerial vehicles at the base; identifying a status of each of the plurality of the unmanned aerial vehicles; and controlling, based on the status of each of the plurality of the unmanned aerial vehicles, the display of the notification list.

(An aspect 3) A non-transitory computer readable memory has stored thereon a program configured to cause a computer to: display, on a terminal, a notification list of notifications including information on each of a plurality of unmanned aerial vehicles under control of a base for the plurality of the unmanned aerial vehicles, the terminal being used by a worker who performs an inspection for each of the plurality of the unmanned aerial vehicles at the base; identify a status of each of the plurality of the unmanned aerial vehicles; and control, based on the status of each of the plurality of the unmanned aerial vehicles, the display of the notification list.

### BRIEF DESCRIPTION OF THE DRAWINGS

FIG. 1 is a diagram illustrating a schematic configuration example of a drone base system S.

FIG. 2 is a diagram illustrating a schematic configuration example of a drone Dn.

FIG. 3 is a diagram illustrating a schematic configuration example of a worker terminal Tm.

FIG. 4 is a diagram illustrating an example of a notification list screen displayed on the worker terminal Tm.

FIG. 5 is a diagram illustrating a schematic configuration example of a base management server MS.

FIG. 6 is a diagram illustrating an example of a notification priority master table.

FIG. 7 is a diagram illustrating an example of functional blocks in a control unit 33.

FIG. 8 is a conceptual diagram illustrating an example of a display order according to a notification priority of the drone Dn.

FIG. 9 is a diagram illustrating an example of an evacuation warning message displayed on a notification list screen.

FIG. 10 is a flowchart illustrating an example of a processing executed by the control unit 33 of the base management server MS.

FIG. 11 is a diagram illustrating a notification priority adjustment processing (EXAMPLE 1) according to a drone status “t1 MINUTES BEFORE TAKE-OFF” or “t1 MINUTES BEFORE LANDING”.

FIG. 12 is a diagram illustrating a notification priority adjustment processing (EXAMPLE 2) according to a drone status “LANDING”.

FIG. 13 is a diagram illustrating an example of a warning determination processing for causing a worker W1 to evacuate from a port Pl.

### DETAILED DESCRIPTION

Hereinbelow, one or more embodiments of the present invention will be described with reference to the drawings. The following embodiment is an embodiment in a case where the present invention is applied to a drone base system used in a base (hereinafter referred to as a “drone base”) for a plurality of drones. Incidentally, in the present embodiment, the drone has been described as an example of an unmanned aerial vehicle, but the present invention is also applicable to a flying robot and the like other than the drone.

### [1. Configuration and Operation Outline of Drone Base System S]

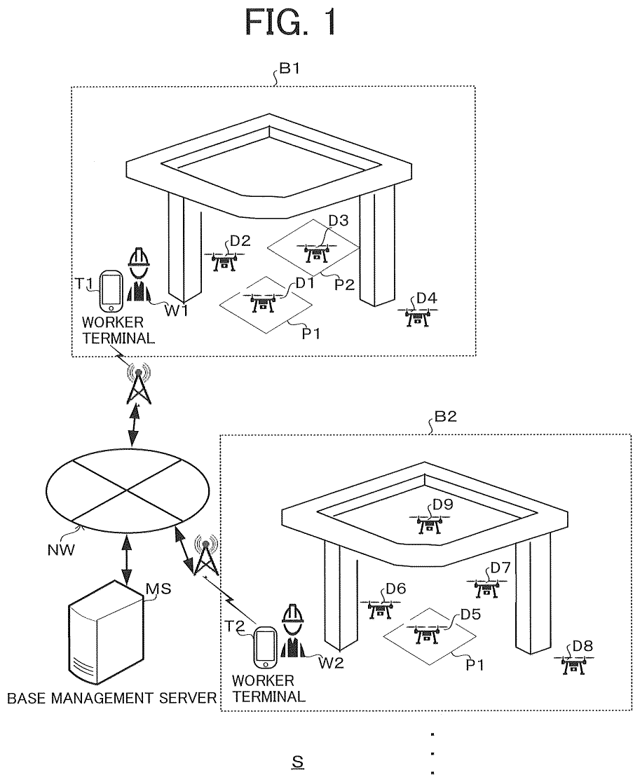

First, a description will be given as to a configuration and an operation outline of a drone base system S according to the present embodiment with reference to FIG. 1. FIG. 1 is a diagram illustrating a schematic configuration example of the drone base system S. As illustrated in FIG. 1, the drone base system S includes a plurality of drones Dn (n=1, 2, 3 . . . ), a plurality of worker terminals Tm (m=1, 2 . . . ), a base management server MS (an example of an information processing device and a predetermined server), and the like. Each of the drone Dn, the worker terminal Tm, and the base management server MS is connected to a communication network NW. The communication network NW includes, for example, the Internet, a mobile communication network and a radio base station thereof, and the like.

The drone Dn is an example of an unmanned flying object, and is also referred a multi-copter or an UAV (Unmanned Aerial Vehicle). The drone Dn can fly according to remote control by an operator from the ground or autonomously fly, and is used for, for example, delivery, surveying, photographing, monitoring, and the like. The drone Dn is managed by a GCS (Ground Control Station) connected to the communication network NW. For example, the GCS may be mounted as an application on a drone pilot (manipulator) terminal, or may be configured by one or more servers or the like.

Moreover, the drone Dn is under the control (in other words, jurisdiction) of any one of the plurality of drone bases Bm. The drone bases Bm install ports Pl (l=1, 2 . . . ) where the drone Dn can take off and land. Incidentally, a plurality of the ports Pl may be installed in one drone base Bm. In the example of FIG. 1, each of the drones D1 to D4 is under the control of the drone base B1. For example, the drone D1 departs (takes off) from the port P1 in the drone base B1, and returns (lands) to the drone base B1. Moreover, each of the drones D5 to D9 is under the control of the drone base B2. For example, the drone D5 departs from the port P1 in the drone base B2, and returns to the drone base B2. However, one drone Dn may be under the control of the plurality of the drone bases Bm (i.e., one drone Dn may belong to the plurality of the drone bases Bm). Incidentally, the number of drones Dn to be controlled by one drone base Bm is not particularly limited.

The worker terminal Tm is a terminal used by a worker (a base staff) Wm who inspects (a pre-flight inspection) the drone Dn in the drone base Bm. For example, the worker Wm visually inspects a predetermined portion of the drone Dn or touches and inspects a predetermined portion of the drone Dn. In the example of FIG. 1, the worker terminal T1 is used by the worker W1 who performs the inspection at the drone base B1. Moreover, the worker terminal T2 is used by the worker W2 who performs the inspection at the drone base B2. Incidentally, a plurality of workers Wm may stay at (belong to) one drone base Bm to perform work including the inspection.

The base management server MS is composed of one or a plurality of server computers that manages information on the drone base Bm for each drone base Bm. The information on the drone base Bm includes, for example, information on the drone Dn under the control of the drone base Bm, information on the worker terminal Tm used in the drone base Bm, and information on the worker Wm who uses the worker terminal Tm. The base management server MS can identify the drone base Bm (a base in charge) for which the worker Wm who logs in by operating the worker terminal Tm is in charge. Then, the base management server MS may cause the worker terminal Tm to display a list (hereinafter referred to as the “notification list”) of notifications including drone information (e.g., information on take-off or landing of the drone Dn) related to the plurality of drone Dn under the control of the identified drone base Bm.

### [1-1. Configuration and Function of Drone Dn]

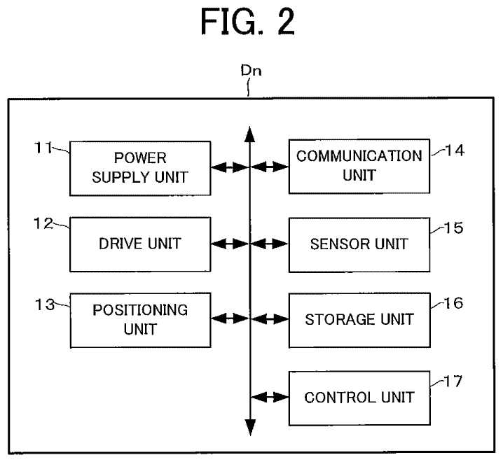

Next, a configuration and a function of the drone Dn will be described with reference to FIG. 2. FIG. 2 is a diagram illustrating a schematic configuration example of the drone Dn. As illustrated in FIG. 2, the drone Dn includes a power supply unit 11, a drive unit 12, a positioning unit 13, a communication unit 14, a sensor unit 15, a storage unit 16, a control unit 17, and the like. Furthermore, the drone Dn includes a propeller (a rotor), which is a horizontal rotary wing, an arm pipe for attaching the propeller to a drone main body (a housing), and the like. Incidentally, in a case where the drone Dn is used for delivery of an article, the drone Dn includes a holding mechanism or the like for holding the article.

The power supply unit 11 includes a detachable battery (an electric storage device) and the like. The power supply unit 11 supplies (supplies electricity) power stored in the battery to each unit of the drone Dn. Moreover, the power supply unit 11 sequentially measures a remaining battery capacity. Battery information indicating the remaining battery capacity measured by the power supply unit 11 is output to the control unit 17. The drive unit 12 includes a motor, a rotation shaft, and the like. The drive unit 12 rotates the plurality of rotors by a motor, a rotation shaft, and the like that are driven in accordance with a control signal output from the control unit 17.

The positioning unit 13 includes a radio wave receiver, an altitude sensor, and the like. The positioning unit 13 receives, for example, a radio wave transmitted from a satellite of a GNSS (Global Navigation Satellite System) such as a GPS (Global Positioning System) by a radio wave receiver, and sequentially detects, on the basis of the radio wave, a current position (latitude and longitude) of the drone Dn in the horizontal direction. Position information indicating the current position detected by the positioning unit 13 is output to the control unit 17. Furthermore, the positioning unit 13 may detect the current position (altitude) of the drone Dn in the vertical direction by the altitude sensor. In this case, the position information includes altitude information indicating the altitude of the drone Dn.

The communication unit 14 has an antenna and a wireless communication function, and is responsible for controlling communication performed via the communication network NW. The sensor unit 15 includes various sensors used to control the drone Dn. Examples of the various sensors include a geomagnetic sensor, a triaxial angular speed sensor, a triaxial acceleration sensor, an atmospheric pressure sensor, an optical sensor, and the like. The optical sensor includes a camera (for example, an RGB camera and an IR (Infrared ray) camera) and the like. Sensing information sensed by the sensor unit 15 is output to the control unit 17. The storage unit 16 includes a nonvolatile memory or the like, and stores various programs and data. Moreover, the storage unit 16 stores a vehicle ID (identification information) for identifying the drone Dn.

The control unit 17 includes at least one CPU (Central Processing Unit), an ROM (Read Only Memory), an RAM (Random Access Memory), and the like, and controls the drone Dn on the basis of the position information from the positioning unit 13 and the sensing information from the sensor unit 15. Such control includes control of a rotation speed of a propeller, control of a position, a posture, and a traveling direction of the drone Dn, and the like. The position information (that is, the position information from the positioning unit 13) of the drone Dn is transmitted to the GCS via the communication network NW along with the vehicle ID (aircraft ID) of the drone Dn. Then, the position information and the vehicle ID of the drone Dn are transmitted from the GCS to the base management server MS. Incidentally, the position information and the vehicle ID of the drone Dn may be transmitted from the drone Dn to the base management server MS.

Moreover, the control unit 17 has a self-diagnosis function, and performs inspection for each item (each inspection item) on whether a predetermined portion (for example, the power supply unit 11, the drive unit 12, the positioning unit 13, the communication unit 14, the sensor unit 15, or the like) of the drone Dn normally operates. Inspection result information including inspection results and the vehicle ID of the drone Dn that has performed the inspection are transmitted to the GCS via the communication network NW. Then, the inspection result information is transmitted from the GCS to the base management server MS. Incidentally, the inspection result information may be transmitted from the drone Dn to the base management server MS.

### [1-2. Configuration and Function of Worker Terminal Tm]

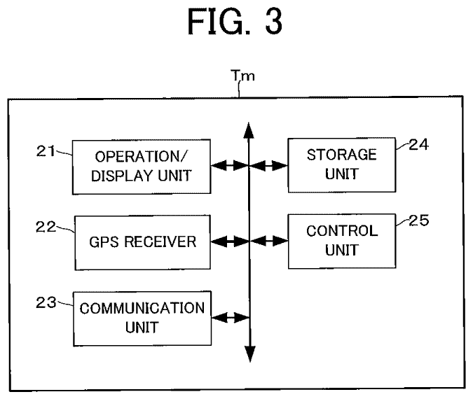

Next, a configuration and a function of the worker terminal Tm will be described with reference to FIG. 3. FIG. 3 is a diagram illustrating a schematic configuration example of the worker terminal Tm. The worker terminal Tm includes an operation/display unit 21, a GPS receiver 22, a communication unit 23, a storage unit 24, a control unit 25, and the like. Incidentally, as the worker terminal Tm, for example, a portable terminal such as a smartphone or a tablet, or a notebook personal computer can be applied. The worker terminal Tm may include a voice processing unit and a speaker. The operation/display unit 21 has, for example, an input function of receiving an instruction (an input instruction, a selection instruction, or the like) by a finger, a pen, or the like of the worker, and a display function of displaying various screens on the display. The GPS receiver 22 receives, for example, a radio wave transmitted from GPS satellites, and detects the current position of the worker terminal Tm. The position information (latitude and longitude) indicating the position detected by the GPS receiver 22 is output to the control unit 25.

The communication unit 23 has a wireless communication function and is responsible for controlling communication performed via the communication network NW. Incidentally, the communication unit 23 may have a short-distance (short-range) wireless communication function such as Bluetooth (registered trademark). The storage unit 24 includes a nonvolatile memory or the like, and stores various programs and pieces of data. The various programs include an operating system (OS), a worker application, and a web browser. The worker application is a program for acquiring and displaying screens for supporting the worker Wm from the base management server MS. Incidentally, the worker application may be downloaded from a predetermined server to the worker terminal Tm.

The control unit 25 (an example of a computer) includes at least one CPU, an ROM, an RAM, and the like, and executes processing according to the worker application stored in the ROM (alternatively, the storage unit 24). When the worker application is activated in response to an instruction of the worker Wm, the control unit 25 displays a login screen on the display. Then, when a user ID and a password are input by the worker Wm through the login screen, the control unit 25 transmits a login request including the user ID and the password to the base management server MS via the communication unit 23 and the communication network NW. The user ID is identification information for identifying the worker Wm. The login request may include position information of the worker terminal Tm. The position information of the worker terminal Tm may be transmitted to the base management server MS along with the user ID of the worker Wm even after the worker Wm logs in. Incidentally, the control unit 25 may detect the current position of the worker terminal Tm based on communication between the communication unit 23 and an access point installed in a short-distance wireless communication area, and transmit the position information indicating the detected position to the base management server MS.

Then, after the worker Wm logs in according to the login request, the screen for supporting the worker Wm is displayed on the display of the worker terminal Tm by the worker application. The screen for supporting the worker Wm includes a pre-flight check screen and a notification list screen and the like. The pre-flight check screen is a screen for inputting and confirming, for each inspection item, the inspection results of the drone Dn under the control of the drone base Bm for which the worker Wm is in charge. The inspection result information including the inspection results input by the worker Wm through the pre-flight check screen and the vehicle ID of the inspected drone Dn, is transmitted to the base management server MS along with the user ID via the communication network NW.

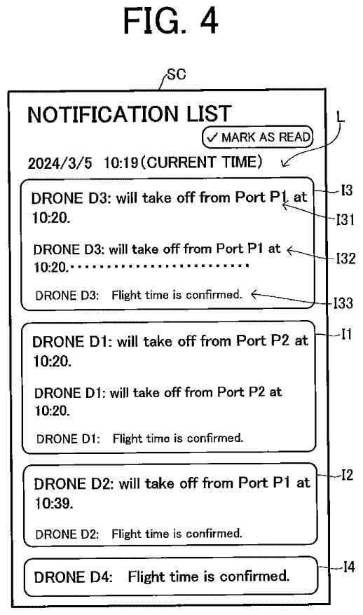

The notification list screen is a screen for displaying the notification list containing drone information related to the drone Dn under the control of the drone base Bm for which the worker Wm is in charge. FIG. 4 is a diagram illustrating an example of the notification list screen displayed on the worker terminal Tm. As shown in FIG. 4, a notification list L is displayed on the notification list screen SC. The notification list L includes drone information I1 to I4 regarding each of the drones D1 to D4 under the control of the drone base B1 for which the worker Wm is in charge. Each of the drone information I1 to I4 includes a drone name (and/or the vehicle ID of the drone) and a notification message for the worker W1. In the notification list L, the display order of the drone information I1 to I4 is controlled (i.e., the display order is changed) according to, for example, a priority (hereinafter referred to as the “notification priority”) of a notification (hereinafter referred to as a “drone notification”) of each of the drones D1 to D4. Here, the notification priority is importance for notifying drone information, and indicates degree to which the worker Wm should address with priority. The notification priority is identified based on a status (hereinafter referred to as “drone status”) of the drone Dn and the like. (details will be described later). For example, the notification priority may change in response to a change of the drone status and the like. As a result, the display order of the drone information can also change.

Here, the drone status is distinguished into a plurality of types, for example, “FLIGHT TIME CONFIRMED”, “t10 MINUTES BEFORE TAKE-OFF”, “t1 (<t10) MINUTES BEFORE TAKE-OFF”, “RETURN”, “t1 MINUTES BEFORE LANDING”, “LANDING”, and the like. In this case, the drone status transitions as follows: “FLIGHT TIME CONFIRMED” to(→) “t10 MINUTES BEFORE TAKE-OFF” to(→) “t1 MINUTES BEFORE TAKE-OFF” to(→) “RETURN” to(→) “t1 MINUTES BEFORE LANDING” to(→) “LANDING”. Here, the “FLIGHT TIME CONFIRMED” indicates that the scheduled take-off time of the drone Dn has been confirmed (determined). The “t10 MINUTES BEFORE TAKE-OFF” indicates that the current time is t10 minutes before take-off of the drone Dn. The “t10” (parameter) is set in advance, for example, about “10” to “15”. The “t1 MINUTES BEFORE TAKE-OFF” indicates that the current time is t1 minutes before take-off of the drone Dn. The “t1” (parameter) is set in advance, for example, “1” to “3”. The “RETURN” indicates that the drone Dn has begun returning to the drone base Bm. The “t1 MINUTES BEFORE LANDING” indicates that the current time is t1 minute before landing of the drone Dn. The “LANDING” indicates that the drone Dn has landed at port Pl.

In the example of FIG. 4, the title I31 of the drone notification and the details I32 of the drone notification are displayed as the notification messages in the drone information I3. Furthermore, in the example of FIG. 4, the past notification message I33 that was previously displayed (notified) is displayed at the bottom of the notification details I32. Namely, the drone information includes the past notification messages in chronological order so that the worker Wm can check each past notification message again. However, the past notification message may be updated (i.e., overwritten) by the latest notification message. Moreover, the drone information may be cleared from the display (i.e., erasing of the drone information) when the worker Wm confirms it. For example, the drone information may be cleared from the display when the worker Wm selects a read receipt button indicating that the worker Wm has read the information. Alternatively, the drone information may be cleared from the display when a predetermined time has elapsed since the display. Incidentally, the past notification message I33 may be displayed outside the display frame of the drone information I3.

### [1-3. Configuration and Function of Base Management Server MS]

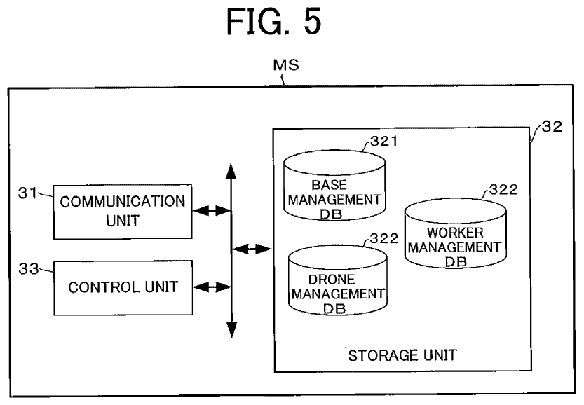

Next, a configuration and a function of the base management server MS will be described with reference to FIG. 5. FIG. 5 is a diagram illustrating a schematic configuration example of the base management server MS. As illustrated in FIG. 5, the base management server MS includes a communication unit 31, a storage unit 32, a control unit 33, and the like. The communication unit 31 controls communication performed via the communication network NW. The inspection result information, the position information of the drone Dn, and the vehicle ID, all of which are transmitted from the GCS or the drone Dn are received by the communication unit 31. The base management server MS can recognize the current position of the drone Dn on the basis of the position information of the drone Dn. The login request transmitted from the worker terminal Tm is received by the communication unit 31. Moreover, the inspection result information, the position information of the worker terminal Tm, and the user ID of the worker Wm, all of which are transmitted from the worker terminal Tm after the login of the worker Wm, are received by the communication unit 31. The base management server MS can recognize the current position of the worker Wm using the worker terminal Tm on the basis of the position information of the worker terminal Tm.

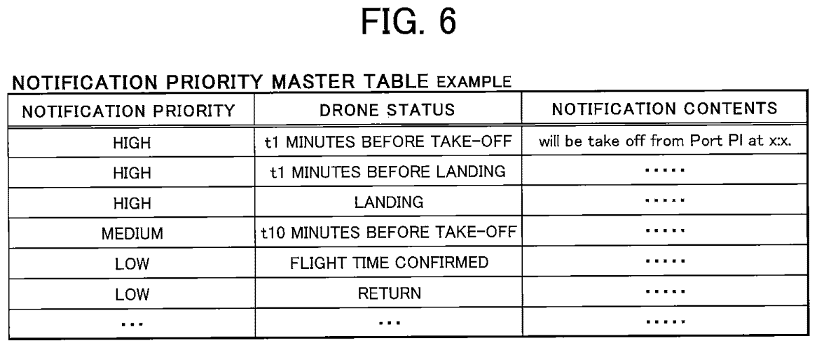

The storage unit 32 includes, for example, a hard disk drive or the like, and stores an operating system, various programs including an application, and the like. Here, the application includes a program for executing a display control method. The program may be stored in a non-transitory computer readable memory. Moreover, the storage unit 32 stores a notification priority master table. The notification priority master table is a table that registers a notification priority and notification content (including one or more notification messages) for each drone status. That is, the notification priority master table registers sets of notification priorities and notification contents (drone notification contents). FIG. 6 is a diagram illustrating an example of the notification priority master table. In the example of FIG. 6, the notification priority “HIGH” is associated with “t1 MINUTES BEFORE TAKE-OFF”, “t1 MINUTES BEFORE LANDING”, and “LANDING” Moreover, the notification priority “MEDIUM” is associated with “t10 MINUTES BEFORE TAKE-OFF”. Moreover, the notification priority “LOW” is associated with “FLIGHT TIME CONFIRMED” and “RETURN”. Incidentally, in the example of FIG. 6, the notification priority is divided into three levels, but may be two or four or more levels. Furthermore, the notification priority may be represented by a numerical value (e.g., 1 (high), 2 (medium), and 3 (low)).

Furthermore, a base management database (DB) 321, a drone management database (DB) 322, and a worker management database (DB) 323 are constructed in the storage unit 32. The base management database 321 is a database for managing information on the drone base Bm. In the base management database 321, for example, a base ID of the drone base Bm, position information of an installation area of the drone base Bm, a port ID of the port Pl installed in the drone base Bm, position information of the port Pl, the vehicle ID of the drone Dn under the control of the drone base Bm, and the like are stored in association with each drone base Bm. Here, the base ID is identification information for identifying the drone base Bm. The port ID is identification information for identifying the port Pl. The position information of the installation area of the drone base Bm is represented by, for example, latitude and longitude for each of multiple points in the installation area of the drone base Bm. The position information of the port Pl indicates, for example, the position (latitude and longitude) of the port Pl.

The drone management database 322 is a database for managing information on the drone Dn. In the drone management database 322, the vehicle ID of the drone Dn, the drone name, a drone schedule, the position information of the drone Dn, the inspection result information, the drone status, and the like are stored in association with each drone Dn. Here, the drone schedule indicates, for example, scheduled times of the inspection (the pre-flight inspection), the take-off, the return, the landing, and the like of the drone Dn. The drone status is suitably updated according to, for example, various information (including information from the drone Dn) received by the communication unit 31, the drone schedule, and instruction information from the administrator, etc. Incidentally, if a plurality of the ports Pl is installed at one drone base Bm, the drone schedule may include the port ID and the position information of the port Pl where the drone Dn is scheduled to use for the take-off or landing.

The worker management database 323 is a database for managing information on the worker Wm. In the worker management database 323, a user ID, a password, a login status, a name, and the like of the worker Wm are stored in association with each worker Wm. Here, the login status indicates whether the worker Wm logs in. When the worker Wm logs in, the position information of the worker terminal Tm used by the worker Wm is stored in the worker management database 323 in association with the user ID of the worker Wm. Incidentally, when the drone base Bm for which the worker Wm is in charge is determined, the base ID of the drone base Bm for which the worker Wm is in charge is stored in the worker management database 323 in association with the user ID of the worker Wm.

The control unit 33 (an example of a computer) includes at least one CPU, an ROM, an RAM, and the like, and performs various processes according to the programs (program code) stored in the storage unit 32 or the non-transitory computer readable memory. The CPU (an example of processor) is configured to access the program code stored in the storage unit 32 or the memory and operate as instructed by the program code. The program code includes: first display control code configured to cause the CPU to display the notification list on worker terminal Tm, first identification code configured to cause the CPU to identify the drone status of each of the plurality of the drones Dn; and second display control code configured to cause the CPU to control the display of the notification list, based on the drone status of each of the plurality of the drones Dn. Moreover, the program code further may include: second identification code configured to cause the CPU to identify a position of the worker Wm; and third identification code configured to cause the CPU to identify a position of the port Pl where the drone Dn is allowed to take off or land. Moreover, the program code further may include fourth identification code configured to cause the CPU to identify a movement direction of the worker Wm. Moreover, the program code further may include fifth identification code configured to cause the CPU to identify, based on the drone status of each of the plurality of the drones Dn, a notification priority of each drone Dn. Moreover, the program code further may include first determination code configured to cause the CPU to calculate a distance between the position of the worker Wm and the position of the port Pl, and to determine whether the calculated distance is equal to or less than a threshold value. Moreover, the program code further may include second determination code configured to cause the CPU to determine whether the movement direction of the worker Wm is a direction approaching (or away from) the position of the port Pl. Moreover, the program code further may include warning code configured to cause the CPU to issue an evacuation warning to the worker Wm, based on the calculated distance being equal to or less than the threshold value. Incidentally, the processor may be implemented using circuitry or processing circuitry which includes general purpose processors, special purpose processors, integrated circuits, ASICS, conventional circuitry and/or combinations thereof which are configured or programmed to perform the disclosed functionality. The processor may be hardware (or a combination of hardware and software) that carry out or are programmed to perform the recited functionality.

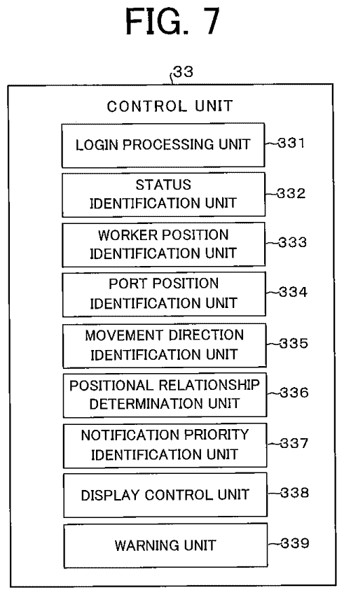

FIG. 7 is a diagram illustrating an example of functional blocks in the control unit 33. For example, according to the program (the program code), the control unit 33 functions as a login processing unit 331, a status identification unit 332, a worker position identification unit 333, a port position identification unit 334, a movement direction identification unit 335, a positional relationship determination unit 336, a notification priority identification unit 337, a display control unit 338, and a warning unit 339, and the like, as illustrated in FIG. 7.

The login processing unit 331 performs a login processing of the worker Wm in response to the login request from the worker terminal Tm. In the login processing, it is determined whether a set of the user ID and the password included in the login request is registered. Then, when the set of the user ID and the password is registered, the worker Wm who uses the worker terminal Tm that has transmitted the login request is identified (identified by the user ID), and the worker Wm logs in.

The status identification unit 332 identifies the drone status of each of the plurality of drones Dn under the control of the drone base Bm for which the worker Wm is in charge, for example, for each notification update timing. Here, it is preferable that the drone status is be identified, for example, from the drone management database 322. The notification update timing may be a timing that arrives every predetermined time interval (e.g., 1 minute), or a timing in which the drone status of any drone Dn among the plurality of drones Dn changes. Incidentally, the change of the drone status can be determined from, for example, the drone schedule.

The worker position identification unit 333 identifies, based on the position information of the worker terminal Tm used by the worker Wm, the position (hereinafter referred to as the “worker position”) of the worker Wm. Here, it is preferable that the worker position is identified multiple times in chronological order. This makes it possible to identify chronological changes of the worker position. Incidentally, if a camera is installed at the drone base Bm, the worker position may be identified by analyzing images captured by the camera.

The port position identification unit 334 identifies the position (hereinafter referred to as the “port position”) of the port Pl in the drone base Bm for which the worker Wm is in charge. Here, it is preferable that the port position is identified, for example, from the base management database 321. If the plurality of the ports Pl are installed at one drone base Bm, the port position identification unit 334 may identify, by referring to the drone schedule, the port position of the port Pl where the drone Dn is scheduled to use for the take-off or landing, or the port position of the port Pl where the drone Dn is during take-off or landing. Incidentally, if a camera is installed at the drone base Bm, the port position may be identified by analyzing images captured by the camera.

The movement direction identification unit 335 identifies, based on the plurality of worker positions identified in chronological order by the worker position identification unit 333, a movement direction (hereinafter referred to as the “worker movement direction”) of the worker Wm. For example, the movement direction identification unit 335 identifies, as the worker movement direction, a direction from a first worker position identified at the beginning to a second worker position identified after the first worker position is identified (e.g., several seconds after the first worker position is identified).

The positional relationship determination unit 336 calculates the distance between the worker position identified by the worker position identification unit 333 and the port position identified by the port position identification unit 334, and determines whether the calculated distance is equal to or less than a threshold value. Furthermore, the positional relationship determining unit 336 determines whether the worker movement direction identified by the movement direction identification unit 335 is a direction approaching the port position identified by the port position identification unit 334. Incidentally, the positional relationship determination unit 336 may determine whether the worker movement direction is a direction away from the port position.

The notification priority identification unit 337 identifies, based on each drone status identified by the status identification unit 332, the notification priority of each drone Dn. That is, each drone status is identified for the display control of the notification list. This makes it possible for the worker Wm to quickly decide which drone notification should be prioritized (in other words, which drone Dn should be addressed with priority), while simplifying and speeding up the processing when the display control of the notification list is performed. For example, it is preferable that the notification priority identification unit 337 refers to the notification priority master table, and acquires, for each notification update timing from the notification priority master table, the notification priority associated with the drone status identified by the status identification unit 332.

Alternatively, depending on a type of the identified drone status, the notification priority identification unit 337 may identify, based on the worker position and the port position in addition to the drone status, the notification priority for each notification update timing. This makes it possible for the worker Wm to more quickly, accurately and effectively decide which drone notification should be prioritized (in other words, which drone Dn should be addressed with priority). More specifically, the notification priority identification unit 337 may adjust (in other words, correct), based on whether the distance between the worker position and the port position is equal to or less than a threshold value (e.g., 10 m), the notification priority acquired (tentatively identified) from the notification priority master table based on the drone status. This makes it possible to control the display of the notification list using a more accurate notification priority.

For example, when it is determined that (i) the drone status of the drone Dn is “t1 MINUTES BEFORE TAKE-OFF” or “t1 MINUTES BEFORE LANDING”, and (ii) the distance between the worker position and the port position is greater than the threshold value (e.g., the worker Wm is not within a radius of 10 m of the port Pl where the drone Dn is scheduled to use for the take-off or landing), the notification priority is changed from “HIGH” to “MEDIUM”. That is, the changed notification priority is finally identified for the display control of the notification list. This is because the worker Wm is at a certain distance away from the port Pl and therefore safety can be ensured, so the notification priority identification unit 337 lowers the notification priority. On the other hand, when it is determined that (i) the drone status of the drone Dn is “t1 MINUTES BEFORE TAKE-OFF” or “t1 MINUTES BEFORE LANDING”, and (ii) the distance between the worker position and the port position is equal to or less than the threshold value, the notification priority remains “HIGH” (status quo).

Moreover, for example, when it is determined that (i) the drone status of the drone Dn is “LANDING”, and (ii) the distance between the worker position and the port position is equal to or less than the threshold value, the notification priority is changed from “HIGH” to “MEDIUM”. This is because the worker Wm can quickly move on to preparing to retrieve drone Dn that has already landed at the port Pl, so the notification priority identification unit 337 lowers the notification priority. On the other hand, when it is determined that (i) the drone status of the drone Dn is “LANDING”, and (ii) the distance between the worker position and the port position is greater than the threshold value, the notification priority remains “HIGH”.

Alternatively, depending on a type of the identified drone status, the notification priority identification unit 337 may identify, based on the worker position, the port position, and the worker movement direction in addition to the drone status, the notification priority for each notification update timing. This also makes it possible for the worker Wm to more quickly, accurately and effectively decide which drone notification should be prioritized. More specifically, the notification priority identification unit 337 may adjust, based on whether the distance between the worker position and the port position is equal to or less than a threshold value (e.g., 10 m) and whether the worker movement direction is a direction approaching the port position (or a direction away from the port position), the notification priority acquired from the notification priority master table based on the drone status. This also makes it possible to control the display of the notification list using a more accurate notification priority.

For example, when it is determined that (i) the drone status of the drone Dn is “t1 MINUTES BEFORE TAKE-OFF” or “t1 MINUTES BEFORE LANDING”, (ii) the distance between the worker position and the port position is greater than the threshold value, and (iii) the worker movement direction is not a direction approaching the port position (e.g., the worker Wm is not approaching the port Pl where the drone Dn is scheduled to use for the take-off or landing), the notification priority is changed from “HIGH” to “MEDIUM”. This is because the worker Wm is at a certain distance away from the port Pl where the drone Dn is scheduled to use for the take-off or landing and the worker Wm is not approaching the port Pl, thereby safety can be ensured, so the notification priority identification unit 337 lowers the notification priority. On the other hand, when it is determined that (i) the drone status of the drone Dn is “t1 MINUTES BEFORE TAKE-OFF” or “t1 MINUTES BEFORE LANDING” and (ii) the distance between the worker position and the port position is equal to or less than the threshold value, the notification priority remains “HIGH”. Alternatively, when it is determined that (i) the drone status of the drone Dn is “t1 MINUTES BEFORE TAKE-OFF” or “t1 MINUTES BEFORE LANDING” and (ii) the worker movement direction is a direction approaching the port position, the notification priority remains “HIGH”. In this case, even if the distance between the worker position and the port position is greater than the threshold value, since the worker Wm is approaching the port Pl where the drone Dn is scheduled to use for the take-off or landing, the notification priority remains “HIGH”.

Moreover, for example, when it is determined that (i) the drone status of the drone Dn is “LANDING”, (ii) the distance between the worker position and the port position is equal to or less than the threshold value, and (iii) the worker movement direction is not a direction away from the port location (e.g., the worker Wm is not moving away from the port Pl where the drone Dn is landing), the notification priority is changed from “HIGH” to “MEDIUM”. This is because the worker Wm can quickly move on to preparing to retrieve drone Dn that has already landed at the port Pl, so the notification priority identification unit 337 lowers the notification priority. On the other hand, when it is determined that (i) the drone status of the drone Dn is “LANDING”, and (ii) the distance between the worker position and the port position is greater than the threshold value, the notification priority remains “HIGH”. Alternatively, when it is determined that (i) the drone status of the drone Dn is “LANDING”, and (ii) the worker movement direction is a direction away from the port location, the notification priority remains “HIGH”. In this case, even if the distance between the worker position and the port position is equal to or less than the threshold value, since the worker Wm is away from the port Pl, the priority remains “HIGH”.

The display control unit 338 transmits, to the worker terminal Tm, display control data for displaying the notification list including drone information of the plurality of the drones Dn under the control of the drone base Bm for which the worker Wm is in charge. As a result, the notification list is displayed on the notification list screen of the worker terminal Tm. At this time, the display control unit 338 controls the display of the notification list according to the notification priority identified by the notification priority identification unit 337. For example, the display control unit 338 controls at least one of a display order and a display mode (display manner) of the drone information in the notification list according to the notification priority identified by the notification priority identification unit 337. This allows the worker Wm to make a quick decision at a glance on which drone notification should be prioritized. Incidentally, when the notification priority is adjusted (corrected) as described above, at least one of the display order and the display mode of the drone information in the notification list is controlled according to the adjusted notification priority.

For example, in controlling the display order of the drone information, the display control unit 338 performs the display control so as to display the drone information of the drone Dn with a higher notification priority at an upper (higher) position (i.e., at a display position that is more easily visible for the worker Wm) in the notification list. This allows the worker Wm to make a quick decision at a glance on which drone notification should be prioritized. In the example of FIG. 4, since the notification priority of the drone D3 is the highest, the drone information I3 of the drone D3 is displayed at the highest (topmost) position in the notification list L. It is preferable that the display order in the notification list is updated according to the notification priority identified (or adjusted) for each notification update timing described above. As a result of such updates, the display order and the notification content may change, or the status quo may be maintained.

Incidentally, when the drone status changes at the notification update timing, the notification content associated with the drone status after the change may be acquired from the notification priority master table and transmitted to the worker terminal Tm along with the notification priority.

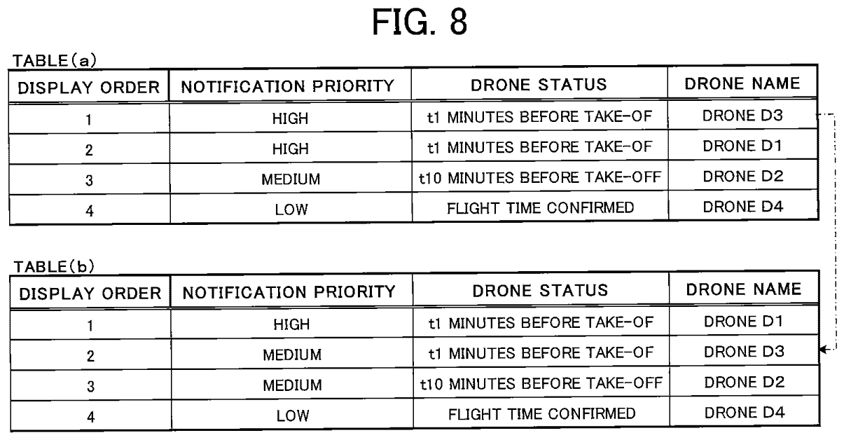

FIG. 8 is a conceptual diagram illustrating an example of the display order according to the notification priority of the drone Dn. The example of Table (a) in FIG. 8 shows the display order according to notification priority determined based on the drone status. In this case, since the notification priority of the drone D1 and the notification priority of the drone D3 are the same, the drone information I3 of the drone D3 corresponding to the most recently updated notification is displayed at an upper position than drone information I1 of the drone D1. On the other hand, the example of Table (b) in FIG. 8 shows the display order according to the notification priority adjusted based on the worker position, the port position and the like. In this case, since the notification priority of the drone D3 has been changed from “HIGH” to “MEDIUM”, the drone information I1 of the drone D1 is displayed at an upper position than the drone information I3 of the drone D3.

In controlling the display mode of the drone information, the display control unit 338 performs the display control so as to display the drone information of the drone Dn with a higher notification priority in (with) a more conspicuous (prominent) display mode (i.e., display mode that attracts the attention of the worker Wm) in the notification list. Here, examples of displaying in the conspicuous display mode include setting a size of characters, etc. representing the drone information to a larger size than standard setting (i.e., standard size), setting a color of characters, etc. representing the drone information to a brighter color (e.g., red) than standard setting (i.e., standard color), and setting a thickness of line of characters, etc. representing the drone information to a thicker line than standard setting (i.e., standard thickness). Here, the characters, etc. may be at least one of letters, symbols, patterns, and shapes. Incidentally, examples of displaying in the conspicuous display mode may include transitioning characters, etc. representing the drone information from a non-flashing state to a flashing state, setting a color of a region (background, or frame of the region) for displaying characters, etc. representing the drone information to a brighter color than standard setting (i.e., standard color), and setting a thickness of the frame of the region for displaying characters, etc. representing the drone information to a thicker frame than standard setting (i.e., standard thickness).

Moreover, it is preferable that the display mode in the notification list is updated according to the notification priority identified for each of the notification update timings described above, in the same manner as the display order. As a result of such updates, the display mode and the notification content may change, or the status quo may be maintained. Incidentally, the display control unit 338 may perform the display control so as to display the drone information of the drone Dn with a higher notification priority at an upper position and with a more conspicuous display mode in the notification list.

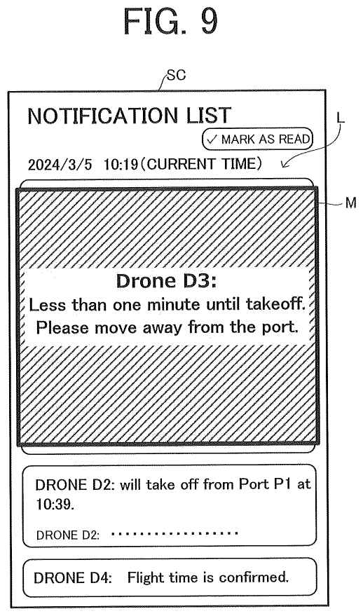

In case where it is determined, by the positional relationship determination unit 336, that the distance between the worker position and the port position is equal to or less than the threshold value, before a predetermined time (e.g., 58 seconds) of the scheduled take-off time of the drone Dn under the control of the drone base Bm for which the worker Wm is in charge, the warning unit 339 issues an evacuation warning to the worker Wm via the worker terminal Tm used by the worker Wm. This makes it possible to improve safety of the worker Wm. For example, the warning unit 339 causes the operator terminal Tm to display an evacuation warning message prompting the worker Wm to evacuate from the port Pl to issue the evacuation warning. FIG. 9 is a diagram illustrating an example of the evacuation warning message displayed on the notification list screen. In the example of FIG. 9, the pop-up screen showing the evacuation warning message M is displayed on the notification list L on the notification list screen SC. Incidentally, whether the current time is a predetermined time before the scheduled take-off time of drone Dn, may be determined by the positional relationship determination unit 336 or by the warning unit 339.

Moreover, as another example, the warning unit 339 may issue the evacuation warning to the worker Wm via the worker terminal Tm used by the worker Wm in a case where it is determined, by the positional relationship determination unit 336, that the worker movement direction is the direction approaching the port position even when it is determined, by the positional relationship determination unit 336, that the distance between the worker position and the port position is greater than the threshold value before the predetermined time of the scheduled take-off time of the drone Dn under the control of the drone base Bm for which the worker Wm is in charge. This makes it possible to more improve safety of the worker Wm. On the other hand, the warning unit 339 may not issue the evacuation warning in a case where it is determined, by the positional relationship determination unit 336, that the worker movement direction is the direction away from the port position even when it is determined, by the positional relationship determination unit 336, that the distance between the worker position and the port position is equal to or less than the threshold value. This makes it possible to improve safety of the worker Wm and to prevent unnecessary evacuation warning from being issued. Incidentally, the warning unit 339 may cause the evacuation warning message to be audibly output from a speaker of the worker terminal Tm.

### [2. Operation of Drone Base System S]

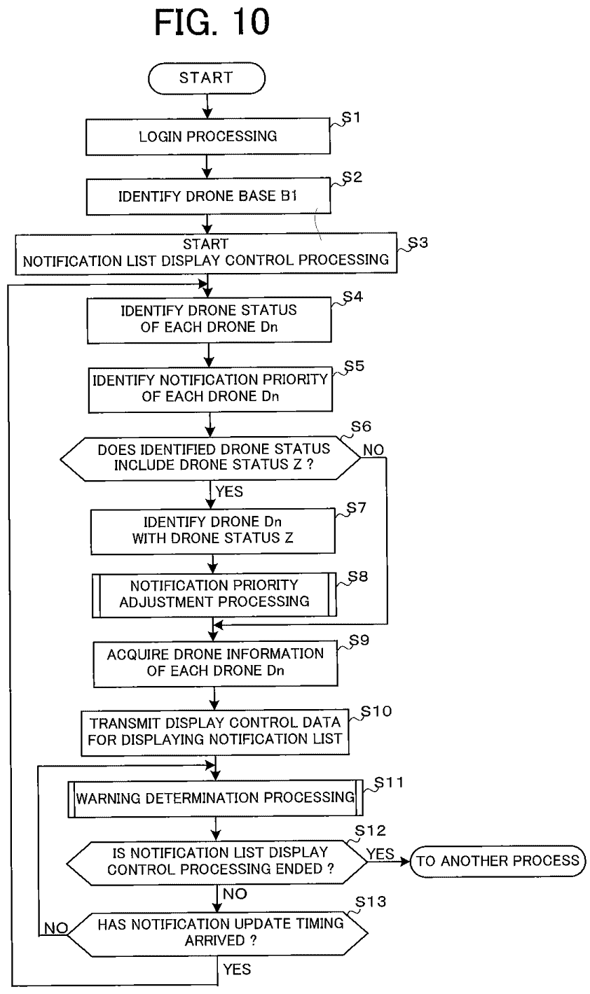

Next, an operation of the drone base system S will be described with reference to FIG. 10. FIG. 10 is a flowchart illustrating an example of a processing executed by the control unit 33 of the base management server MS. Incidentally, in the following description of the operation, a description will be given, as an example, as to a case in which the worker W1 using the worker terminal T1 works at the drone base B1. In the worker terminal T1, when the worker application is activated in response to an instruction of the worker W1, the login screen is displayed on the display. Then, the worker terminal T1 transmits, to the base management server MS, the login request including the user ID and password input by the worker W1 through the login screen.

The processing illustrated in FIG. 10 is started, for example, when the login request from the worker terminal T1 is received by the base management server MS. When the processing illustrated in FIG. 10 is started, the control unit 33 executes the login processing by the login processing unit 331 in response to the received login request (step S1). In the login processing, it is determined whether the set of the user ID and the password included in the login request is registered. For example, when the set of the user ID and the password included in the login request is stored in the worker management database 323, it is determined that the set of the user ID and the password is registered, and the worker W1 using the worker terminal T1 logs in.

Next, the control unit 33 identifies the drone base B1 for which the logged-in worker W1 is in charge (step S2). For example, the control unit 33 refers to the worker management database 323 and identifies, based on the base ID associated with the user ID of the logged-in worker W1, the drone base B1 for which the worker W1 is in charge. Incidentally, if the base ID is not associated with the user ID of the worker W1 in the worker management database 323, the control unit 33 may identify, based on the position information received from the worker terminal T1, the worker position when the worker W1 logs in. Then, the control unit 33 may identify, based on the identified worker position and the position information of the installation area of the drone base Bm managed in the base management database 321, the drone base B1 for which the worker W1 is in charge.

Next, when the control unit 33 receives a notification list display request from the worker terminal T1 in response to, for example, a notification list display instruction by the worker W1, the control unit 33 starts a notification list display control processing (step S3). Moreover, the notification list screen is displayed on the worker terminal T1 in response to the notification list display instruction. Incidentally, although not shown in FIG. 10, in the notification list display control processing, the base management server MS receives, multiple times in a chronological manner from the worker terminal T1, the position information of the worker terminal T1 used by the worker W1. When the notification list display control processing is started, the control unit 33 identifies, by the status identification unit 332, the drone status of each of the plurality of the drones Dn (e.g., drones D1 to D4) under the control of the drone base B1 identified in step S2 (step S4). Next, the control unit 33 identifies (e.g., acquires from the notification priority master table) the notification priority of each drone Dn, based on the respective drone status identified in step S4 and the notification priority master table (step S5).

Next, the control unit 33 determines whether the drone status identified in step S4 includes a drone status Z that requires determination of a positional relationship (hereinafter referred to as the “worker & port positional relationship”) between the worker W1 and the port Pl (i.e., the port Pl in the drone base B1) (step S6). The drone status that requires the determination of the worker & port positional relationship, is set in advance. For example, “t1 MINUTES BEFORE TAKE-OFF”, “t1 MINUTES BEFORE LANDING”, or “LANDING” may be applicable to such drone status.

Then, when it is determined that the drone status identified in step S4 includes the drone status Z that requires the determination of the worker & port positional relationship (step S6: YES), the drone Dn with the drone status Z is identified (for example, identified by the vehicle ID) (step S7), and the process proceeds to step S8. Incidentally, a plurality of drones Dn may be identified in step S7. On the other hand, when it is determined that the drone status identified in step S4 does not include the drone status Z that requires the determination of the worker & port positional relationship (step S6: NO), the process proceeds to step S9.

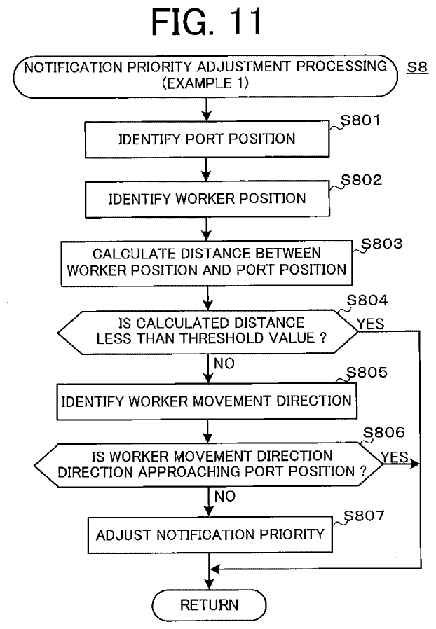

In step S8, the control unit 33 executes a notification priority adjustment processing according to the drone status Z which requires determination of the worker & port positional relationship. FIG. 11 is a diagram illustrating a notification priority adjustment processing (EXAMPLE 1) according to the drone status “t1 MINUTES BEFORE TAKE-OFF” or “t1 MINUTES BEFORE LANDING”. In the notification priority adjustment processing (EXAMPLE 1) illustrated in FIG. 11, the control unit 33 refers to the drone schedule of the drone Dn identified in step S7, and identifies, by the port position identification unit 334, the port position of the port Pl where the identified drone Dn is scheduled to use for the take-off or landing (step S801). Next, the control unit 33 identifies, by the worker position identification unit 333, the worker position of the worker W1 a plurality of times in a chronological manner (step S802), based on the position information received the plurality of times in a chronological manner from the worker terminal T1.

Next, the control unit 33 calculates a distance (e.g., a linear distance) between the worker position (e.g., the latest worker position) identified in step S802 and the port position identified in step S801 (step S803). Next, the control unit 33 determines, by the positional relationship determination unit 336, whether the distance calculated in step S803 is equal to or less than a threshold value (e.g., 10 m) (step S804). When it is determined that the calculated distance is equal to or less than the threshold value (step S804: YES), the notification priority identified in step S5 is maintained (e.g., “HIGH” is maintained) and returns to the process shown in FIG. 10 (i.e., the process proceeds to step S9). On the other hand, when it is determined that the calculated distance is greater than the threshold value (step S804: NO), the process proceeds to step S805.

In step S805, the control unit 33 identifies, based on the plurality of the worker positions identified in chronological order in step S802, the worker movement direction of the worker W1. Next, the control unit 33 determines whether the worker movement direction identified in step S805 is a direction approaching the port position identified in step S801 (step S806). When it is determined that the worker movement direction is the direction approaching the port position (step S806: YES), the notification priority identified in step S5 is maintained (e.g., “HIGH” is maintained) and returns to the process shown in FIG. 10. On the other hand, when it is determined that the worker movement direction is not the direction approaching the port position (step S806: NO), the process proceeds to step S807.

In step S807, the control unit 33 adjusts (e.g., changes from “HIGH” to “MEDIUM”) the notification priority of the drone Dn identified in step S7 (i.e., the notification priority identified in step S5) and returns to the process shown in FIG. 10. If a plurality of the drones Dn are identified in step S7, the notification priority adjustment processing (EXAMPLE 1) illustrated in FIG. 11 may be executed for each drone Dn. Incidentally, the processes of steps S805 and S806 may be omitted in the notification priority adjustment processing (EXAMPLE 1) illustrated in FIG. 11. In this case, when it is determined that the calculated distance is greater than the threshold value (step S804: NO), the process proceeds to step S807.

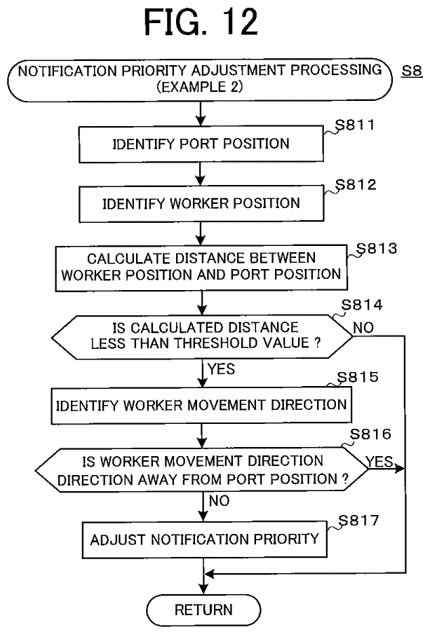

On the other hand, FIG. 12 is a diagram illustrating a notification priority adjustment processing (EXAMPLE 2) according to the drone status “LANDING”. In the notification priority adjustment processing (EXAMPLE 2) illustrated in FIG. 12, the control unit 33 identifies, by referring to the drone schedule of the drone Dn identified in step S7, the port position of the port Pl where the drone Dn is landing (step S811). Alternatively, the position indicated by the position information of the drone Dn identified in step S7 may be identified as the port position of the port Pl. Incidentally, the processes in steps S812 to S814 are similar to those in steps S802 to S804 shown in FIG. 11. when it is determined in step S814 that the calculated distance is greater than the threshold value (step S814: NO), the notification priority identified in step S5 is maintained (e.g., “HIGH” is maintained) and returns to the process shown in FIG. 10. On the other hand, when it is determined that the calculated distance is equal to or less than the threshold value (step S814: YES), the process proceeds to step S815.

In step S815, the control unit 33 identifies, based on the plurality of the worker positions identified in chronological order in step S812, the worker movement direction of the worker W1. Next, the control unit 33 determines whether the worker movement direction identified in step S815 is a direction away from the port position identified in step S811 (in other words, whether the worker movement direction is not a direction approaching the port position) (step S816). When it is determined that the worker movement direction is the direction away from the port position (step S816: YES), the notification priority identified in step S5 is maintained (e.g., “HIGH” is maintained) and returns to the process shown in FIG. 10. On the other hand, when it is determined that the worker movement direction is not the direction away from the port position (step S816: NO), the process proceeds to step S817.

In step S817, the control unit 33 adjusts the notification priority of the drone Dn identified in step S7 (e.g., changes from “HIGH” to “MEDIUM”) and returns to the process shown in FIG. 10. When a plurality of the drones Dn are identified in step S7, the notification priority adjustment processing (EXAMPLE 2) illustrated in FIG. 12 may be performed for each drone Dn. Incidentally, the processes of steps S815 and S816 may be omitted in the notification priority adjustment processing (EXAMPLE 2) illustrated in FIG. 12. In this case, when it is determined that the calculated distance is equal to or less than the threshold value (step S814: NO), the process proceeds to step S817.

In step S9, the control unit 33 acquires the drone information including the respective drone names (or vehicle IDs) and the respective notification messages of the plurality of drones Dn whose the notification priority has been identified in step S5 (or adjusted in step S8). Here, the notification message of the drone Dn may be acquired from the notification priority master table, based on the drone status identified in step S4. At this time, the time (e.g., the scheduled take-off time) to be included in the notification message may be identified from the drone schedule of the target drone Dn. Incidentally, the notification message may be acquired from the notification priority master table in step S5.

Next, the control unit 33 transmits, by the display control unit 338, a display control data for displaying the notification list according to each notification priority identified in step S5 (or adjusted in step S8) to the worker terminal T1, and thereby causes the notification list to be displayed on the notification list screen of the worker terminal T1 (step S10). The display control data includes, for example, each notification priority and each drone information acquired in step S9. As a result, in the notification list displayed on the worker terminal Tm, the drone information of each drone Dn is displayed in the display order (or the display mode) according to each notification priority. Incidentally, the display control data may be data (e.g., data of a web page) in which the drone information of each drone Dn is arranged (laid out) in the display order (or the display mode) according to each notification priority. In this case, the display control data does not need to include each notification priority.

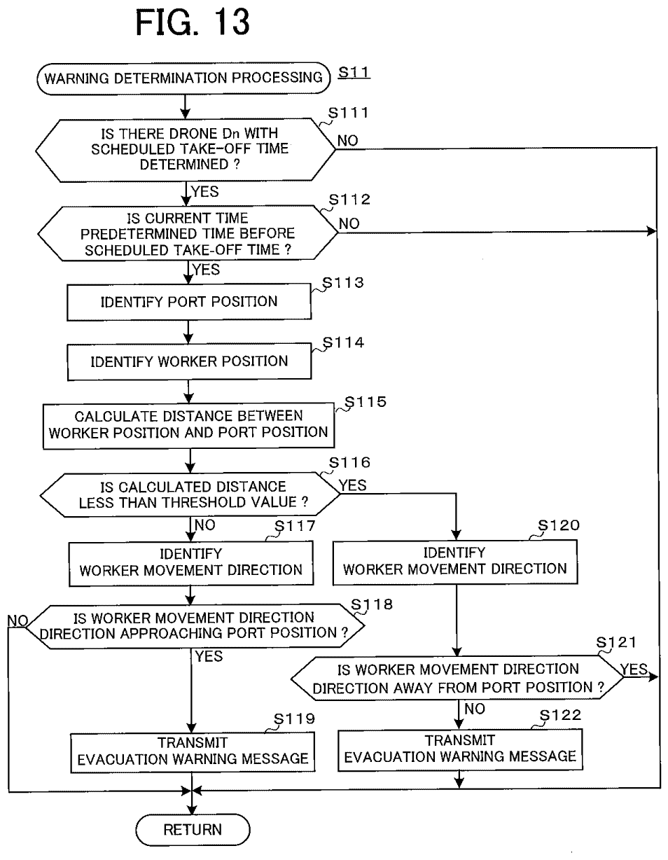

Next, the control unit 33 executes a warning determination processing for causing the worker W1 to evacuate from the port Pl (step S11). FIG. 13 is a diagram illustrating an example of the warning determination processing for causing the worker W1 to evacuate from the port Pl. In the warning determination processing illustrated in the FIG. 13, the control unit 33 determines whether there is a drone Dn whose the scheduled take-off time has been determined (i.e., there is a drone Dn with a scheduled take-off time determined) among the plurality of the drone Dn under the control of the drone base B1 (step S111). When it is determined that there is the drone Dn whose the scheduled take-off time has been determined (step S111: YES), the process proceeds to step S112. On the other hand, when it is determined that there is no drone Dn whose scheduled take-off time has been determined (step S111: NO), returns to the process shown in FIG. 10 (i.e., the process proceeds to step S12). Incidentally, for example, in a case where the drone Dn is used to deliver an ordered item (e.g., product), the drone Dn that has not completed the pre-flight inspection, is not be selected as a flight target (e.g., it is not be assigned as a flight target when an order is received). Therefore, the drone Dn whose the scheduled take-off time has been determined, has completed the pre-flight inspection.

In step S112, the control unit 33 determines whether the current time has become a predetermined time before the scheduled take-off time of the drone Dn determined to be “YES” in step S111. That is, it is determined whether the predetermined time (9:50) before the scheduled take-off time (e.g., 10:00) has arrived. When it is determined that the current time has become the predetermined time (step S112: NO), returns to the process shown in FIG. 10. On the other hand, when it is determined that the current time has become the predetermined time (step S112: YES), the process proceeds to step S113. Incidentally, the processes in steps S113 to S116 are similar to those in steps S801 to S804 shown in FIG. 11.

Then, in step S116, when it is determined that the calculated distance is greater than the threshold value (step S116: NO), the process proceeds to step S117. On the other hand, when it is determined that the calculated distance is equal to or less than the threshold value (step S116: YES), the process proceeds to step S120. Incidentally, when it is determined that the calculated distance is equal to or less than the threshold value (step S116: YES), the process may proceed to step S120. In this case, the processes of steps S120 and S121 may be omitted.

In step S117, the control unit 33 identifies, based on the plurality of the worker positions identified in chronological order in step S114, the worker movement direction of the worker W1. Next, the control unit 33 determines whether the worker movement direction identified in step S117 is a direction approaching the port position identified in step S113 (step S118). When it is determined that the worker movement direction is the direction approaching the port position (step S118: YES), the evacuation warning message is transmitted to the worker terminal Tm by the warning unit 339 (step S119) and returns to the process shown in FIG. 10. As a result, the pop-up screen showing the evacuation warning message is displayed on the notification list on the notification list screen of the worker terminal Tm. Incidentally, the evacuation warning message may be audibly output from a speaker of the worker terminal Tm. On the other hand, when it is determined that the worker movement direction is the direction approaching the port position (step S118: NO), returns to the process shown in FIG. 10 without the evacuation warning message being transmitted to the worker terminal Tm.

In step S120, the control unit 33 identifies, based on the plurality of the worker positions identified in chronological order in step S114, the worker movement direction of the worker W1. Next, the control unit 33 determines whether the worker movement direction identified in step S120 is a direction away from the port position identified in step S113 (step S121). When it is determined that the worker movement direction is not the direction away from the port position (step S121: NO), the evacuation warning message is transmitted to the worker terminal Tm by the warning unit 339 (step S122), and returns to the process shown in FIG. 10. On the other hand, when it is determined that the worker movement direction is the direction away from the port position (step S121: YES), returns to the process shown in FIG. 10 without the evacuation warning message being transmitted to the worker terminal Tm.

In step S12, the control unit 33 determines whether to end the notification list display control processing. For example, when the control unit 33 receives a screen transition request from the worker terminal T1 in response to a transition instruction to another screen by the worker W1, the control unit 33 determines that the notification list display control processing is terminated (step S12: YES) and proceeds to another processing. Incidentally, in the other processing, when the notification list display request is received from the worker terminal T1, the notification list display control processing may be started. On the other hand, it is determined that the notification list display control processing is not terminated (step S12: NO), the process proceeds to step S13.

In step S13, the control unit 33 determines whether a notification update timing has arrived. It is preferable that the notification update timing is set by a timer to arrive at, for example, every predetermined time interval. When it is determined that the notification update timing has not arrived (step S13: NO), the process returns to step S11. On the other hand, when it is determined that the notification update timing has arrived (step S13: YES), the process returns to step S4. Returning to step S4, the same process as described above is performed.

Incidentally, returning to step S4, the respective drone statuses of the plurality of the drones Dn under the control of the drone base B1 are identified again, but only for the drone Dn whose the drone status has been changed (i.e., when the drone status identified this time differs from the previously identified drone status), the processes after step S5 may be performed. In step S9 of this case, the control unit 33 acquires the drone information including the drone name and the notification message of the drone Dn whose the drone status has been changed.

Then, the control unit 33 transmits, to the worker terminal Tm, the display control data including the notification priority identified in step S5 (or adjusted in step S8) and the drone information acquired in step S9, with respect to the drone Dn whose the drone status has been changed. This makes it possible to more efficiently change the display order (or the display mode) of the drone information of the drone Dn whose the drone status has been changed since the previous drone status in the notification list being displayed on the worker terminal Tm, thereby reducing the processing load of the base management server MS. In this case, when the notification priority of the drone Dn whose the drone status has been changed is the same as that of another drone Dn (i.e., the other drone Dn whose the drone information is displayed), the drone information of the drone Dn whose the drone status has been changed is displayed at an upper position than the drone information of the other drone Dn in the notification list.

As described above, according to the above-described embodiment, the base management server MS causes the worker terminal Tm used by the worker Wm inspecting the drone Dn at the drone base Bm to display the notification list including drone information of the plurality of the drones Dn under the control of the drone base Bm, identifies the drone status of each of the drones Dn, identifies the notification priority of each drone Dn based on the identified drone status, and controls the display of the notification list according to the identified notification priority. Therefore, it is possible for the worker Wm to quickly decide which drone notification should be prioritized.

For example, when the plurality of the drones D1 to D4 are operated simultaneously from one drone base T1, it is expected that the respective notifications for the drones D1 to D4 are simultaneously received by the worker terminal T1 of the worker W1. In this case, according to the above-described embodiment, it is possible to appropriately and quickly communicate, to the worker W1, importance of the notification along with which notification is for which drone Dn. Moreover, it is s possible to prevent overlooking notifications regarding the take-off and landing of the drone Dn. Furthermore, according to the above-described embodiment, the base management server MS may adjust the notification priority and control the display of the notification list, based on the position or the movement (i.e., the chronological change of the position) of the worker Wm in addition to the drone status of each drone Dn. Therefore, it is possible for the worker Wm to more quickly and accurately decide which drone notification should be prioritized.

Incidentally, the above-described embodiment is one embodiment of the present invention, and the present invention is not limited to the above-described embodiment, changes from the above-described embodiment can be made on various configurations and the like within a scope not departing from the gist of the present invention, and such cases shall be also included in the technical scope of the present invention. In the above-described embodiment, by using the notification priority identified based on the respective drone statuses, etc. of the drones Dn, it is possible to simplify and speed up the processing when the display control of the notification list is performed. However, the display of the notification list may be controlled based on the respective drone statuses of the drones Dn without the notification priority being used. In this case, for example, the base management server MS stores reference information in advance that defines, by round robin (brute force), which drone information corresponding to which drone status among the plurality of the drone statuses is to be displayed in the upper display order. Alternatively, the base management server MS stores reference information in advance that defines, by round robin, which drone information corresponding to which drone status among the plurality of the drone statuses is to be displayed in the conspicuous display mode. Then, when the respective drone statuses of the drones Dn are identified, the base management server MS controls the display of the notification list by referring to the stored reference information. Moreover, the display of the notification list may be controlled based on the worker position and the port position in addition to the drone status without the notification priority being used. In this case, the base management server MS may change, based on whether the distance between the worker position and the port position is equal to or less than the threshold value, the display order or the display mode identified based on the reference information and the respective drone statuses. That is, the identified display order or the identified display mode is changed based on a condition associated with the drone status that requires determination of the worker & port positional relationship. Furthermore, the display of the notification list may be controlled based on the worker position, the port position, the worker movement direction in addition to the drone status without the notification priority being used. In this case, the base management server MS may change, based on whether the distance between the worker position and the port position is equal to or less than the threshold value and whether the worker movement direction is a direction approaching the port position (or a direction away from the port position), the display order or the display mode identified based on the reference information and the respective drone statuses. That is, the identified display order or the identified display mode is changed based on a plurality of conditions associated with the drone status that requires determination of the worker & port positional relationship.

Moreover, in the above-described embodiment, the worker terminal Tm (the control unit 25) may acquire, from the base management server MS in accordance with the worker application, the notification list including drone information of the plurality of the drones Dn under the control of the drone base Bm, and display the acquired notification list. Then, the worker terminal Tm (control unit 25) may acquire the respective drone statuses of the drones Dn from the base management server MS, identify the respective notification priorities of drones Dn based on the respective drone statuses, and control the display of the notification list according to the notification priorities. In this case, it is preferable that the notification priority master table may be stored in the storage unit 24 of the worker terminal Tm. Moreover, the worker terminal Tm may store the reference information in advance in the same manner as the base management server MS, and control the display of the notification list by referring to the reference information when the respective drone statuses of the drones Dn are acquired. Moreover, in the same manner as the base management server MS, the worker terminal Tm may change the display order or display mode identified based on the reference information and the respective drone statuses, based on whether the distance between the worker position and the port position acquired from the base management server MS is equal to or less than the threshold value. Furthermore, in the same manner as the base management server MS, the worker terminal Tm may change the display order or display mode identified based on the reference information and the respective drone statuses, based on whether the distance between the worker position and the port position is equal to or less than the threshold value and whether the worker movement direction is a direction approaching the port position (or a direction away from the port position).

### <Note>

[1] An information processing device according to the present disclosure includes: a first display control unit configured to display, on a terminal, a notification list of notifications including information on each of a plurality of unmanned aerial vehicles under control of a base for the plurality of the unmanned aerial vehicles, the terminal being used by a worker who performs an inspection for each of the plurality of the unmanned aerial vehicles at the base; a first identification unit configured to identify a status of each of the plurality of the unmanned aerial vehicles; and a second display control unit configured to control the display of the notification list on the basis of the status of each of the plurality of the unmanned aerial vehicles. This makes it possible for the worker performing the inspection of the unmanned aerial vehicles to quickly decide a notification for which unmanned aerial vehicle should be prioritized.

[2] The information processing device described in [1] above, further includes: a second identification unit configured to identify a position of the worker; and a third identification unit configured to identify a position of a port where the unmanned aerial vehicle is allowed to take off or land, the port being installed within the base, wherein the second display control unit is configured to control the display of the notification list on the basis of the position of the worker and the position of the port, in addition to the status of each of the plurality of the unmanned aerial vehicles. This makes it possible for the worker performing the inspection of the unmanned aerial vehicles to quickly and accurately decide a notification for which unmanned aerial vehicle should be prioritized.

[3] The information processing device described in [2] above, further includes a fourth identification unit configured to identify a movement direction of the worker, wherein the second display control unit is configured to control the display of the notification list on the basis of the position of the worker, the position of the port, and the movement direction of the worker, in addition to the status of each of the plurality of the unmanned aerial vehicles. This makes it possible for the worker performing the inspection of the unmanned aerial vehicles to quickly and accurately decide a notification for which unmanned aerial vehicle should be prioritized.

[4] The information processing device described in [1] above, further includes a fifth identification unit configured to identify a notification priority of each unmanned aerial vehicle on the basis of the status of each of the plurality of the unmanned aerial vehicles, wherein the second display control unit is configured to control the display of the notification list according to the notification priority of each unmanned aerial vehicle. This makes it possible for the worker performing the inspection of the unmanned aerial vehicles to quickly decide a notification for which unmanned aerial vehicle should be prioritized, while simplifying and speeding up the processing when the display control of the notification list is performed.

[5] The information processing device described in [4] above, further includes: a second identification unit configured to identify a position of the worker; and a third identification unit configured to identify a position of a port where the unmanned aerial vehicle is allowed to take off or land, the port being installed within the base, wherein the fifth identification unit is configured to identify the notification priority of each unmanned aerial vehicle on the basis of the position of the worker and the position of the port, in addition to the status of each of the plurality of the unmanned aerial vehicles. This makes it possible for the worker performing the inspection of the unmanned aerial vehicles to quickly and accurately decide a notification for which unmanned aerial vehicle should be prioritized, while simplifying and speeding up the processing when the display control of the notification list is performed.

[6] The information processing device described in [5] above, further includes a fourth identification unit configured to identify a movement direction of the worker; and wherein the fifth identification unit is configured to identify the notification priority of each unmanned aerial vehicle on the basis of the position of the worker, the position of the port, and the movement direction of the worker, in addition to the status of each of the plurality of the unmanned aerial vehicles. This makes it possible for the worker performing the inspection of the unmanned aerial vehicles to quickly and accurately decide a notification for which unmanned aerial vehicle should be prioritized, while simplifying and speeding up the processing when the display control of the notification list is performed.

[7] The information processing device described in [5] above, further includes a first determination unit configured to calculate a distance between the position of the worker and the position of the port, and to determine whether the calculated distance is equal to or less than a threshold value, wherein the fifth identification unit is configured to adjust the notification priority on the basis of a first determination result of whether the calculated distance is equal to or less than the threshold value. This makes it possible to control the display of the notification list using a more accurate notification priority.

[8] The information processing device described in [7] above, further includes a second determination unit configured to determine whether the movement direction of the worker is a direction approaching the position of the port, wherein the fifth identification unit is configured to adjust the notification priority on the basis of the first determination result and a second determination result of whether the movement direction of the worker is the direction approaching the position of the port. This makes it possible to control the display of the notification list using a more accurate notification priority.

[9] In the information processing device described in any one of [4] to [8] above, wherein the second display control unit is configured to control at least one of a display order and a display mode of information on each unmanned aerial vehicle in the notification list according to the notification priority of each unmanned aerial vehicle. This makes it possible for the worker performing the inspection of the unmanned aerial vehicles to quickly and easily decide a notification for which unmanned aerial vehicle should be prioritized.

[10] In the information processing device described in any one of [4] to [9] above, wherein the second display control unit is configured to compare the notification priorities of the plurality of unmanned aerial vehicles, and to display the information on the unmanned aerial vehicle with higher notification priority at an upper position in the notification list. This makes it possible for the worker performing the inspection of the unmanned aerial vehicles to quickly and easily decide a notification for which unmanned aerial vehicle should be prioritized.

[11] The information processing device described in any one of [1] to [10] above, further includes: a second identification unit configured to identify a position of the worker; a third identification unit configured to identify a position of a port where the unmanned aerial vehicle is allowed to take off or land, the port being installed within the base; a first determination unit configured to calculate, before a predetermined time of a scheduled take-off time of the unmanned aerial vehicle, a distance between the position of the worker and the position of the port, and to determine whether the calculated distance is equal to or less than a threshold value; and a warning unit configured to issue an evacuation warning to the worker via the terminal in a case where it is determined, by the first determination unit, that the calculated distance is equal to or less than the threshold value. This makes it possible to improve safety of the worker.

[12] The information processing device described in [11] above, further includes: a fourth identification unit configured to identify a movement direction of the worker; and a second determination unit configured to determine whether the movement direction of the worker is a direction approaching the position of the port, wherein the warning unit is configured to issue the evacuation warning to the worker in a case where it is determined, by the second determination unit, that the movement direction of the worker is the direction approaching the position of the port even when it is determined, by the first determination unit, that the calculated distance is not equal to or less than the threshold value. This makes it possible to more improve safety of the worker.

[13] The information processing device described in [11] above, further includes: a fourth identification unit configured to identify a movement direction of the worker; and a second determination unit configured to determine, before a predetermined time of a scheduled take-off time of the unmanned aerial vehicle, whether the movement direction of the worker is a direction away from the position of the port, wherein the warning unit is configured to not issue the evacuation warning to the worker in a case where it is determined, by the second determination unit, that the movement direction of the worker is the direction away from the position of the port even when it is determined, by the first determination unit, that the calculated distance is equal to or less than the threshold value. This makes it possible to improve safety of the worker and to prevent unnecessary evacuation warning from being issued.

[14] A display control method executed by one or more computers, according to the present disclosure, includes: displaying, on a terminal, a notification list of notifications including information on each of a plurality of unmanned aerial vehicles under control of a base for the plurality of the unmanned aerial vehicles, the terminal being used by a worker who performs an inspection for each of the plurality of the unmanned aerial vehicles at the base; identifying a status of each of the plurality of the unmanned aerial vehicles; and controlling, based on the status of each of the plurality of the unmanned aerial vehicles, the display of the notification list.

[15] A program according to the present disclosure, is configured to cause a computer to: display, on a terminal, a notification list of notifications including information on each of a plurality of unmanned aerial vehicles under control of a base for the plurality of the unmanned aerial vehicles, the terminal being used by a worker who performs an inspection for each of the plurality of the unmanned aerial vehicles at the base; identify a status of each of the plurality of the unmanned aerial vehicles; and control, based on the status of each of the plurality of the unmanned aerial vehicles, the display of the notification list.

### REFERENCE SIGNS LIST

11 Power supply unit
12 Drive unit
13 Positioning unit
14 Communication unit
15 Sensor unit
16 Storage unit
17 Control unit
21 Operation/display unit
22 GPS receiver
23 Communication unit
24 Storage unit
25 Control unit
31 Communication unit
32 Storage unit
33 Control unit
331 Login processing unit
332 Status identification unit
333 Worker position identification unit
334 Port position identification unit
335 Movement direction identification unit
336 Positional relationship determination unit
337 Notification priority identification unit
338 Display control unit
339 Warning unit
Dn Drone
Tm Worker terminal
MS Base Management server
Wm Worker
Bm Base
Pl Port
S Drone base system

What is claimed is:

1. An information processing device comprising:
at least one memory configured to store program code; and at least one processor configured to access the program code and operate as instructed by the program code, the program code including:
first display control code configured to cause the at least one processor to display, on a terminal, a notification list of notifications including information on each of a plurality of unmanned aerial vehicles under control of a base for the plurality of the unmanned aerial vehicles, the terminal being used by a worker who performs an inspection for each of the plurality of the unmanned aerial vehicles at the base;
first identification code configured to cause the at least one processor to identify a status of each of the plurality of the unmanned aerial vehicles; and
second display control code configured to cause the at least one processor to control, based on the status of each of the plurality of the unmanned aerial vehicles, the display of the notification list.

2. An information processing device according to claim 1, the program code further including:
second identification code configured to cause the at least one processor to identify a position of the worker; and
third identification code configured to cause the at least one processor to identify a position of a port where the unmanned aerial vehicle is allowed to take off or land, the port being installed within the base,
wherein the second display control code is configured to cause the at least one processor to control the display of the notification list on the basis of the position of the worker and the position of the port, in addition to the status of each of the plurality of the unmanned aerial vehicles.

3. An information processing device according to claim 2, the program code further including fourth identification code configured to cause the at least one processor to identify a movement direction of the worker,
wherein the second display control code is configured to cause the at least one processor to control the display of the notification list on the basis of the position of the worker, the position of the port, and the movement direction of the worker, in addition to the status of each of the plurality of the unmanned aerial vehicles.

4. An information processing device according to claim 1, the program code further including fifth identification code configured to cause the at least one processor to identify, based on the status of each of the plurality of the unmanned aerial vehicles, a notification priority of each unmanned aerial vehicle,
wherein the second display control code is configured to cause the at least one processor to control the display of the notification list according to the notification priority of each unmanned aerial vehicle.

5. An information processing device according to claim 4, the program code further including:
second identification code configured to cause the at least one processor to identify a position of the worker; and
third identification code configured to cause the at least one processor to identify a position of a port where the unmanned aerial vehicle is allowed to take off or land, the port being installed within the base,
wherein the fifth identification code is configured to cause the at least one processor to identify the notification priority of each unmanned aerial vehicle on the basis of the position of the worker and the position of the port, in addition to the status of each of the plurality of the unmanned aerial vehicles.

6. An information processing device according to claim 5, the program code further including fourth identification code configured to cause the at least one processor to identify a movement direction of the worker; and
wherein the fifth identification code is configured to cause the at least one processor to identify the notification priority of each unmanned aerial vehicle on the basis of the position of the worker, the position of the port, and the movement direction of the worker, in addition to the status of each of the plurality of the unmanned aerial vehicles.

7. An information processing device according to claim 5, the program code further including first determination code configured to cause the at least one processor to calculate a distance between the position of the worker and the position of the port, and to determine whether the calculated distance is equal to or less than a threshold value,
wherein the fifth identification code is configured to cause the at least one processor to adjust the notification priority on the basis of a first determination result of whether the calculated distance is equal to or less than the threshold value.

8. An information processing device according to claim 7, the program code further including second determination code configured to cause the at least one processor to determine whether the movement direction of the worker is a direction approaching the position of the port,
wherein the fifth identification code is configured to cause the at least one processor to adjust the notification priority on the basis of the first determination result and a second determination result of whether the movement direction of the worker is the direction approaching the position of the port.

9. An information processing device according to claim 4,
wherein the second display control code is configured to cause the at least one processor to control at least one of a display order and a display mode of information on each unmanned aerial vehicle in the notification list according to the notification priority of each unmanned aerial vehicle.

10. An information processing device according to claim 4,
wherein the second display control code is configured to cause the at least one processor to compare the notification priorities of the plurality of unmanned aerial vehicles, and to display the information on the unmanned aerial vehicle with higher notification priority at an upper position in the notification list.

11. An information processing device according to claim 1, the program code further including:
second identification code configured to cause the at least one processor to identify a position of the worker;
third identification code configured to cause the at least one processor to identify a position of a port where the unmanned aerial vehicle is allowed to take off or land, the port being installed within the base;
first determination code configured to cause the at least one processor to calculate, before a predetermined time of a scheduled take-off time of the unmanned aerial vehicle, a distance between the position of the worker and the position of the port, and to determine whether the calculated distance is equal to or less than a threshold value; and
warning code configured to cause the at least one processor to issue an evacuation warning to the worker via the terminal, based on the calculated distance being equal to or less than the threshold value.

12. An information processing device according to claim 11, the program code further including:
fourth identification code configured to cause the at least one processor to identify a movement direction of the worker; and
second determination code configured to cause the at least one processor to determine whether the movement direction of the worker is a direction approaching the position of the port,
wherein the warning code is configured to cause the at least one processor to issue the evacuation warning to the worker, when the movement direction of the worker is the direction approaching the position of the port even when the calculated distance is not equal to or less than the threshold value.

13. An information processing device according to claim 11, the program code further including:
fourth identification code configured to cause the at least one processor to identify a movement direction of the worker; and
second determination code configured to cause the at least one processor to determine, before a predetermined time of a scheduled take-off time of the unmanned aerial vehicle, whether the movement direction of the worker is a direction away from the position of the port,
wherein the warning code is configured to cause the at least one processor to not issue the evacuation warning to the worker when that the movement direction of the worker is the direction away from the position of the port even when the calculated distance is equal to or less than the threshold value.

14. A display control method executed by one or more computers comprising:
displaying, on a terminal, a notification list of notifications including information on each of a plurality of unmanned aerial vehicles under control of a base for the plurality of the unmanned aerial vehicles, the terminal being used by a worker who performs an inspection for each of the plurality of the unmanned aerial vehicles at the base;
identifying a status of each of the plurality of the unmanned aerial vehicles; and
controlling, based on the status of each of the plurality of the unmanned aerial vehicles, the display of the notification list.

15. A non-transitory computer readable memory having stored thereon a program configured to cause a computer to:
display, on a terminal, a notification list of notifications including information on each of a plurality of unmanned aerial vehicles under control of a base for the plurality of the unmanned aerial vehicles, the terminal being used by a worker who performs an inspection for each of the plurality of the unmanned aerial vehicles at the base;
identify a status of each of the plurality of the unmanned aerial vehicles; and
control, based on the status of each of the plurality of the unmanned aerial vehicles, the display of the notification list.
